(19) United States
(12) Patent Application Publication
(10) Pub. No.: US 2025/0358795 A1
(43) Pub. Date: Nov. 20, 2025

(54) PXSCH TBS AND CB FOR LONG-SLIV WITH GAPS

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US)

(21) Appl. No.: 18/666,704

(22) Filed: May 16, 2024

(51) Int. Cl. H04W 72/0446; H04L 1/00; H04L 5/00

(52) U.S. Cl. CPC H04W 72/0446; H04L 1/0057; H04L 5/0055

(57) ABSTRACT

PxSCH TBS and CB for long-SLIV with gaps is described. An apparatus is configured to partition time resources associated with a PxSCH into a set of time segments based on physical gaps or logical gaps and based on a long-SLIV associated with a PxSCH TB for the PxSCH. The set of time segments includes two or more time segments and at least two time segments in the set of time segments are separated by a physical gap or a logical gap. The apparatus is configured to generate a set of sub-TBs, that comprise the PxSCH TB, across the set of time segments. Each sub-TB of the set of sub-TBs is within time segments of the set of time segments. The apparatus is configured to transmit, to a second Rx/Tx device, the PxSCH TB.

### TECHNICAL FIELD

The present disclosure relates generally to communication systems, and more particularly, to wireless systems utilizing a long start and length indicator value (long-SLIV).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first receiver (Rx)/transmitter (Tx) (Rx/Tx) device, which may be a user equipment or a network node. The apparatus is configured to partition time resources associated with a physical uplink/downlink shared channel (PxSCH) into a set of time segments based on physical gaps or logical gaps and based on a long-SLIV associated with a PxSCH transport block (TB) for the PxSCH, where the set of time segments includes two or more time segments and at least two time segments in the set of time segments are separated by a physical gap or a logical gap. The apparatus is also configured to generate a set of sub-TBs, comprising the PxSCH TB, across the set of time segments, where each sub-TB of the set of sub-TBs is within a time segment of the set of time segments. The apparatus is also configured to transmit, to a second Rx/Tx device, the PxSCH TB.

In the aspect, the method includes partitioning time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The method also includes generating a set of sub-TBs, comprising the PxSCH TB, across the set of time segments, where each sub-TB of the set of sub-TBs is within a time segment of the set of time segments. The method also includes transmitting, to a second Rx/Tx device, the PxSCH TB.

In the aspect, the computer-readable medium stores computer executable code at an Rx/Tx device, the code when executed by at least one processor causes the at least one processor to partition time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The code when executed by at least one processor also causes the at least one processor to generate a set of sub-TBs, comprising the PxSCH TB, across the set of time segments, where each sub-TB of the set of sub-TBs is within a time segment of the set of time segments. The code when executed by at least one processor also causes the at least one processor to transmit, to a second Rx/Tx device, the PxSCH TB.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating examples of a long-SLIV for a PxSCH.

FIG. 5 is a call flow diagram for wireless communications, in accordance with various aspects of the present disclosure.

FIG. 6 is a diagram illustrating an example of segmentation and associated characteristics for a PxSCH with long-SLIV, in accordance with various aspects of the present disclosure.

FIG. 7 is a diagram illustrating an example of a code block group (CBG) configuration for a PxSCH with long-SLIV, in accordance with various aspects of the present disclosure.

FIG. 8 is a diagram illustrating an example of downlink control information (DCI) gap skipping for a PxSCH with long-SLIV, in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network entities/network nodes (e.g., base stations, gNBs, components in a core network, etc.) and UEs. For instance, a UE in a wireless communication network may communicate in various configurations and using various communication schema with a network node utilizing a physical uplink shared channel (PUSCH) and/or a physical downlink shared channel (PUSCH) (together, generally referred to as “PxSCH”). A repeated PxSCH transmission (e.g., a PUSCH) with multiple segments of back-to-back symbols may be utilized to extend the PxSCH coverage.

However, such repetitions may take different redundancy versions (RVs) of the PxSCH, and each repetition segment is configured to not cross the slot boundary in current solutions. Additional issues with repeated PxSCH transmissions include cases where a SLIV is utilized but may not exceed one slot in length while there are often multiple control channel symbols in a given slot, and thus, the number of resource elements (REs) in prior solutions has a relatively low maximum number and limits the TBS, and further complexities associated with code block (CB) segmentation and rate matching lead to additional inefficiencies. Further, solutions that utilize a jumbo TB of a PxSCH with a long-SLIV to cross slot boundaries have limitations related to TBS and Rx support leading to additional segmentation. Such additional segmentation, however, does not include solutions to account for a TB that spans multiple slots and gap boundaries (e.g., a slot gap, an uplink gap, etc.) where the interference may become more uncorrelated and the CB block error rate (BLER) may change. Nor do current solutions provide configurations for scenarios in which a base station/gNB may assume or determine that such interference may be correlated to advantageously skip gaps.

Various aspects relate generally to communications with a long-SLIV. Some aspects more specifically relate to PxSCH TBS and CBs for long-SLIV with gaps. In some examples, an Rx/Tx device may utilize a PxSCH with a long-SLIV to overcome the issues noted above. For instance, an Rx/Tx device may be configured in aspects for PxSCH TBS and CBs for long-SLIV with gaps to account for gap boundaries and enable TBs to span multiple slots and prevent issues with associated CBs. In some examples, an Rx/Tx device may partition time resources of a PxSCH into time segments based on gaps and a long-SLIV for a TB(s), in which sub-TBs may be generated from the TB(s) and across/within the time segments, for transmission to another Rx/Tx device. In some examples, individual segments may be configured for RVs based on a respective sub-TBS.

Particular aspects of the subject matter described in this disclosure can be implemented to realize one or more of the following potential advantages. In some examples, by utilizing time resource partitioning and TB segmentation for a PxSCH with a long-SLIV, as well as a more uniform time domain DMRS pattern (e.g., given Doppler), the described techniques can be used to extend PxSCH coverage with minimal complexity and reduced DMRS overhead. In some examples, by utilizing time resource partitioning and TB segmentation for a PxSCH with a long-SLIV, the described techniques can be used to span PxSCH TBs over multiple slots and account for uncorrelated interference and slot boundaries/gaps. In some examples, by calculating/determining the TBS, as well as CB segmentation, rate matching, and concatenation with reference to slot boundaries, the described techniques can be used to span PxSCH TBs over multiple slots while maintaining CBs within slots/time segments. In some examples, by configuring CBGs within slots/time segments to have the same/similar interference, the described techniques can be used to apply an associated a cyclic redundancy check (CRC) and acknowledgement (ACK)/negative ACK (ACK/NACK) per CBG. In some examples, by utilizing DCI for dynamic gap skipping, the described techniques can be used to allocate PxSCH TBs and advantageously account for correlated interference across the long-SLIV time span.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

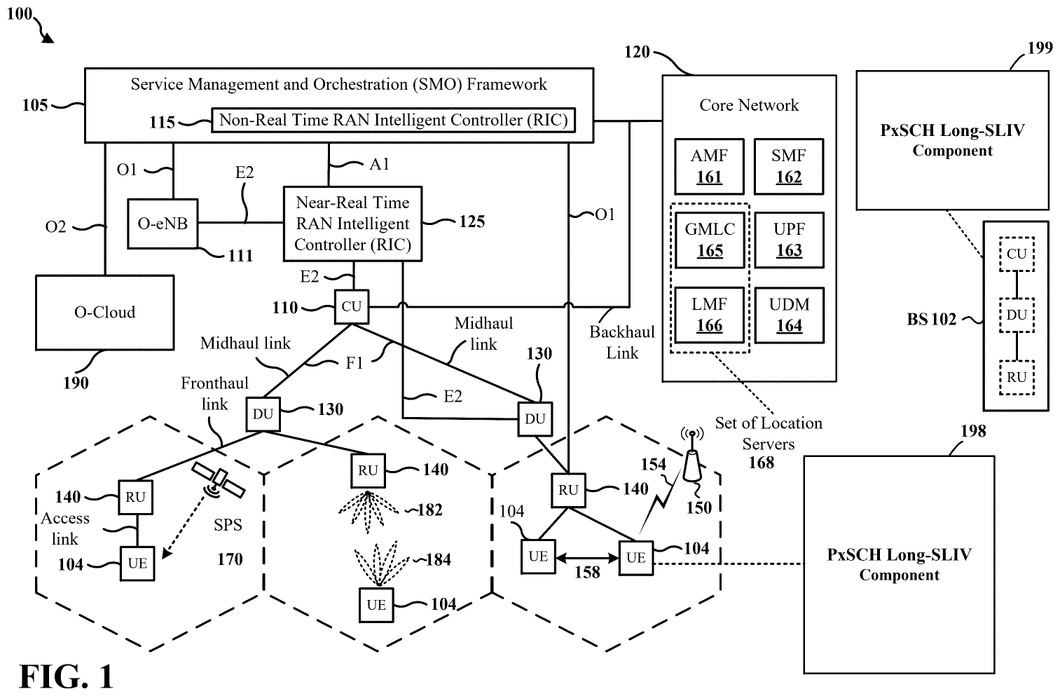

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a PxSCH long-SLIV component 198 (“component 198”) that may be configured to partition time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The component 198 may also be configured to generate a set of sub-TBs, comprising the PxSCH TB, across the set of time segments, where each sub-TB of the set of sub-TBs is within a time segment of the set of time segments. The component 198 may also be configured to transmit, to a second Rx/Tx device, the PxSCH TB. The component 198 may also be configured to receive, via the least one transceiver, DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. In certain aspects, the base station 102 may have a PxSCH long-SLIV component 199 (“component 199”) that may be configured to partition time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The component 199 may also be configured to generate a set of sub-TBs, comprising the PxSCH TB, across the set of time segments, where each sub-TB of the set of sub-TBs is within a time segment of the set of time segments. The component 199 may also be configured to transmit, to a second Rx/Tx device, the PxSCH TB. The component 199 may also be configured to receive, via the least one transceiver, DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. Accordingly, aspects provide for enabling non-contiguous time-domain resources for a PxSCH intervened by one or more time gaps, where a TB is split into multiple sub-TBs across the gaps, and each sub-TB may be treated separately for sub-TBS calculation(s), CRC adding, and/or CBG segmentation, or alternatively treated jointly, as well as enabling self-contained CBGs per sub-TB and dynamic indication of the gap(s).

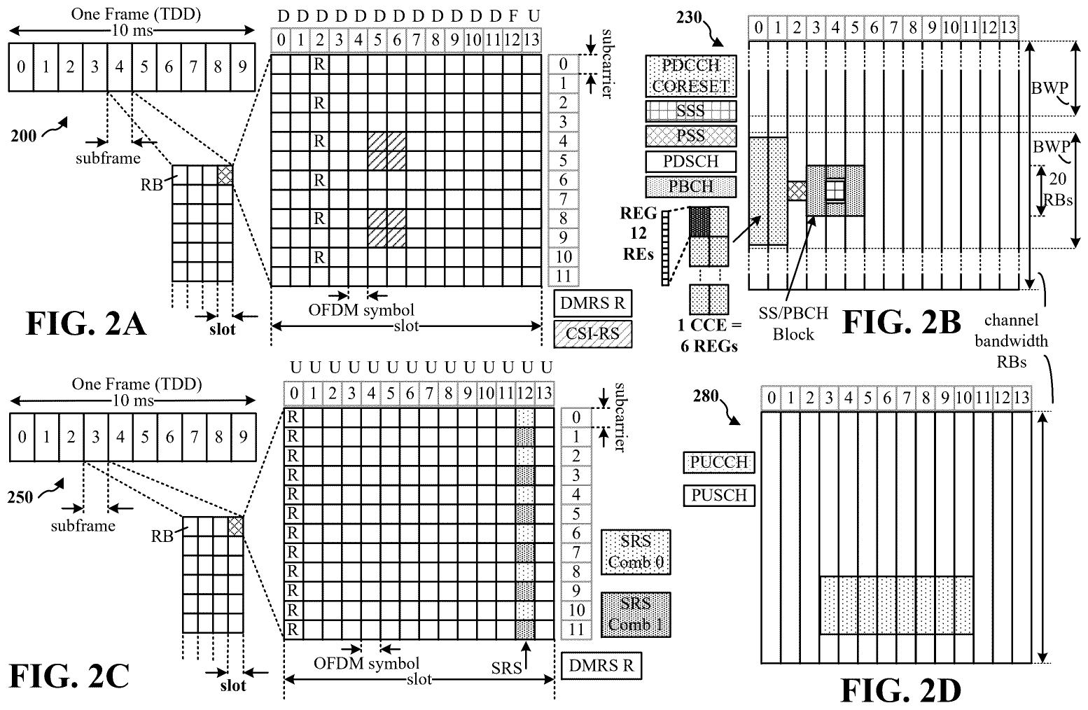

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2ª *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

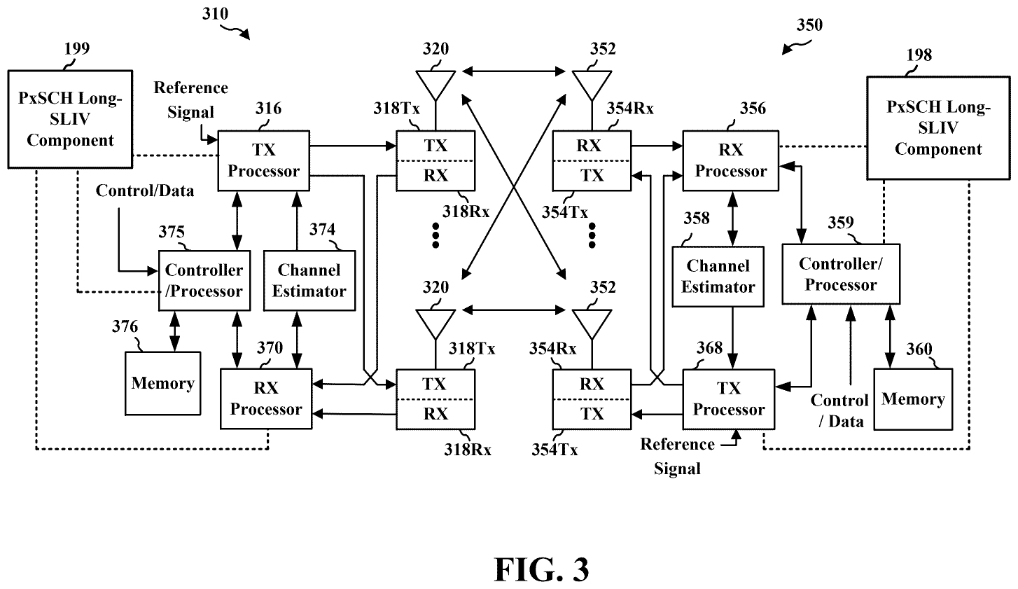

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE in a wireless communication network may communicate in various configurations and using various communication schema with a network node utilizing a PxSCH.” A repeated PxSCH transmission (e.g., a PUSCH) with multiple segments of back-to-back symbols may be utilized to extend the PxSCH coverage. However, such repetitions may take different RVs of the PxSCH, and each repetition segment is configured to not cross the slot boundary in current solutions. Additional issues with repeated PxSCH transmissions include cases where a SLIV is utilized but may not exceed one slot in length while there are often multiple control channel symbols in a given slot, and thus, the number of REs in prior solutions has a relatively low maximum number and limits the TBS, and further complexities associated with CB segmentation and rate matching lead to additional inefficiencies. Further, solutions that utilize a jumbo TB of a PxSCH with a long-SLIV to cross slot boundaries have limitations related to TBS and Rx support leading to additional segmentation. Such additional segmentation, however, does not include solutions to account for a TB that spans multiple slots and gap boundaries (e.g., a slot gap, an uplink gap, etc.) where the interference may become more uncorrelated and the CB BLER may change. Nor do current solutions provide configurations for scenarios in which a base station/gNB may assume or determine that such interference may be correlated to advantageously skip gaps.

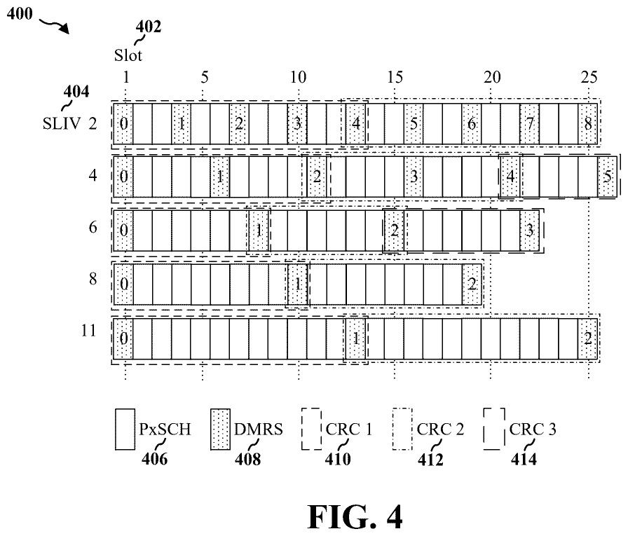

FIG. 4 is a diagram 400 illustrating examples of a long-SLIV for a PxSCH. Diagram 400 shows configurations for combinations of a PxSCH 406, with different values for a long-SLIV 404 (e.g., 2 slots, 4 slots, 6 slots, 8 slots, and 11 slots), with reference to numbers of instances for a slot 402. As noted above, different values for the long-SLIV 404 may cause a TB of the PxSCH 406 to cross boundaries of a given one of the slot 402, which in turn may increase complexities through utilizations of different configurations for DMRS instances 408 and/or different RVs of the PxSCH 406 (e.g., shown as a CRC 410, a CRC 412, and a CRC 414).

Aspects herein relate to long-SLIV (e.g., across slots) PxSCH scheduling. Aspect provide non-contiguous time-domain resources for a PxSCH intervened by one or more time gaps. The TB is split into multiple sub-TBs across the gaps. Each sub-TB can be treated separately for sub-TBS calculation(s), CRC adding, and/or CBG segmentation, or alternatively treated jointly. Aspects also enable self-contained CBGs per sub-TB and dynamic indication of the gap(s). Aspects herein for PxSCH TBS and CBs for long-SLIV with gaps improve upon the issues noted above. An Rx/Tx device may account for gap boundaries and enable TBs to span multiple slots and prevent issues with associated CBs by utilizing a PxSCH with a long-SLIV. An Rx/Tx device may partition time resources of a PxSCH into time segments based on gaps and a long-SLIV for a TB(s), in which sub-TBs may be generated from the TB(s) and across/within the time segments, for transmission to another Rx/Tx device, and individual segments may be configured for RVs based on a respective sub-TBS. Aspect extend PxSCH coverage with minimal complexity and reduced DMRS overhead by utilizing time resource partitioning and TB segmentation for a PxSCH with a long-SLIV, as well as a more uniform time domain DMRS pattern (e.g., given Doppler). Aspects enable the spanning of PxSCH TBs over multiple slots and account for uncorrelated interference and slot boundaries/gaps by utilizing time resource partitioning and TB segmentation for a PxSCH with a long-SLIV. Aspects enable the spanning of PxSCH TBs over multiple slots while maintaining CBs within slots/time segments by calculating/determining the TBS, as well as CB segmentation, rate matching, and concatenation with reference to slot boundaries. Aspects enable the application of an associated a CRC and ACK/NACK per CBG by configuring CBGs within slots/time segments to have the same/similar interference. Aspects also provide for allocation PxSCH TBs and advantageously account for correlated interference across the long-SLIV time span by utilizing DCI for dynamic gap skipping.

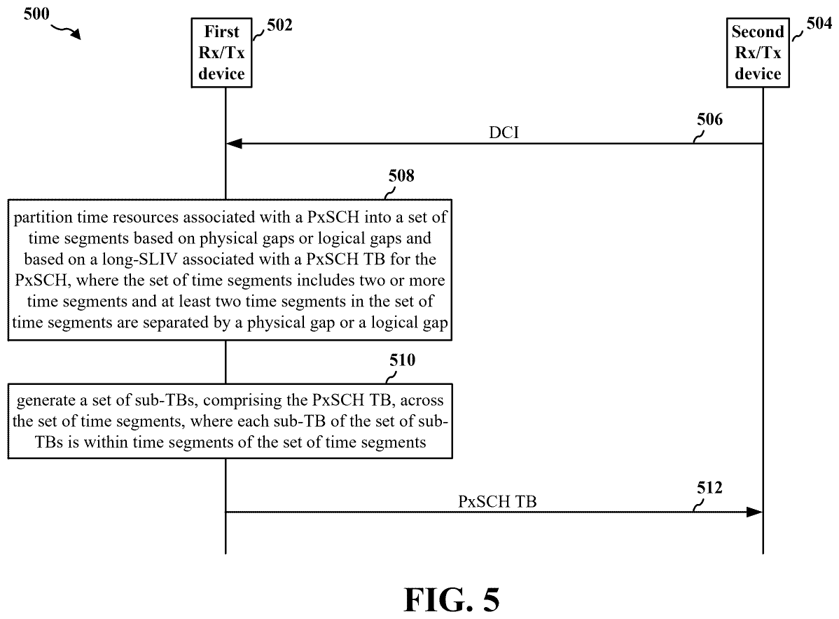

FIG. 5 is a call flow diagram 500 for wireless communications, in various aspects. Call flow diagram 500 illustrates PxSCH TBS and CBs for long-SLIV with gaps for a first Rx/Tx device 502 (e.g., a UE or a base station (such as a gNB or other type of base station or a DU(s), as shown and described herein), by way of example) that communicates with a second Rx/Tx device. In aspects, a network node may comprise one or more network nodes, or portions of network nodes, in various aspects. Aspects described for network nodes herein, generally, may be performed in aggregated form and/or by one or more components in disaggregated form. Additionally, or alternatively, the aspects may be performed by a UE autonomously, in addition to, and/or in lieu of, operations of a base station.

In the illustrated aspect, the first Rx/Tx device 502 may be configured to receive, and the second Rx/Tx device 504 may be configured to transmit/provide, DCI 506. The DCI 506 may be indicative of a skip for a gap(s). The gap(s) may be at least one physical gap or at least one logical gap. In aspects, the skip may be associated with a TB segmentation or a CB segmentation and in accordance with an interference correlation for sub-TBs separated by the at least one physical gap or the at least one logical gap. In some aspects, the DCI 506 may indicate the logical gap(s) as an uplink gap or a transmission time interval (TTI) to TTI (TTI-to-TTI) gap associated with a TDD frame structure in at least one of RRC signaling or a slot format indication (SFI). In aspects, such RRC signaling or SFI may be provided to the first Rx/Tx device 502 (e.g., as a UE) from the second Rx/Tx device (e.g., as a base station, gNB, etc.). In other aspects, the DCI 506 may identify a physical gap(s) for the skip. In aspects, the DCI 506 may indicate the physical gap(s) and/or the logical gap(s) by a reference to a data structure associated with enumerated gap patterns. In aspects, the DCI 506 may indicate the physical gap(s) and/or the logical gap(s) by an association with a TDD frame structure.

The first Rx/Tx device 502 may be configured to partition (at 508) time resources associated with a PxSCH into a set of time segments based on physical gaps or logical gaps and based on a long-SLIV associated with a PxSCH TB 512 for the PxSCH. The set of time segments may include two or more time segments and at least two time segments in the set of time segments are separated by a gap (e.g., a physical gap or a logical gap). In some aspects, the PxSCH TB 512 may include a set of CBs, and each CB of the set of CBs may be within one of the set of time segments.

The time resources may have time resource characteristics that may include a per-segment association for the set of time segments. In aspects, the time resource characteristics may include a sub-TB size (sub-TBS) of each sub-TB of the set of sub-TBs, each CB of the set of CBs, a CB segmentation, a cyclic redundancy check (CRC), a rate matching, a CB concatenation, and/or the like. In some aspects, the time resource characteristics, for each time segment of the set of time segments, may be based on a number of available REs and/or a number of unquantized information bits in each time segment of the set of time segments. In such aspects, each time segment of the set of time segments may have a same modulation order and a same number of layers.

The first Rx/Tx device 502 may be configured to generate (at 510) a set of sub-TBs, comprising the PxSCH TB 512, across the set of time segments. Each sub-TB of the set of sub-TBs may be within time segments of the set of time segments. In aspects, each time segment of the set of time segments may be associated with a respective low density parity check (LDPC) base graph based on the sub-TBS of each time segment. In other aspects, each time segment of the set of time segments may be associated with a same LDPC base graph based on at least one of a minimum sub-TBS, a maximum sub-TBS, or an average sub-TBS over the set of time segments. In either of such aspects, each time segment may include at least one CB (e.g., a set of CBs), a number of CBs in the set of CBs, and a number of sub-TBs in the set of sub-TBs, may be based on a number of unquantized information bits in each time segment of the set of time segments. This may be configured for each time segment individually or for the set of time segments jointly.

In aspects, the CRC may include a single CRC associated with the PxSCH TB 512, while in other aspects the CRC may include a set of sub-CRCs associated with each sub-TB or associated with each time segment in the set of time segments. In such aspects, each sub-CRC in the set of sub-CRCs may be associated with at least one of an ACK/NACK or a retransmission having a per-sub-TB granularity.

In some aspects, the CB segmentation may be associated with each sub-TB of the set of sub-TBs, subsequent to an application of the CRC and a respective low density parity check (LDPC) base graph selection, in accordance with a CB number for each CB in the set of CBs and a number of bits for each CB number. In some aspects, the rate matching and/or the CB concatenation may be associated with each time segment of the set of time segments and may be based on a ratio of a number of coded bits for a channel coding to a number of CBs in a respective time segment of the set of time segments.

In aspects, at least one time segment of the set of time segments includes a respective set of CB groups (CBGs). In such aspects, each respective set of CBGs may include a number of CBs of the set of CBs and is within a respective time segment of the set of time segments. The number of CBs in each CBG of each respective set of CBGs may be based on a per-time segment configuration for the at least one time segment of the set of time segments.

The first Rx/Tx device 502 may be configured to transmit/provide, and the second Rx/Tx device 504 may be configured to receive, the PxSCH TB 512. In some aspects, the first Rx/Tx device 502 may be a UE and the second Rx/Tx device 504 may be a network node (e.g., a base station, gNB, etc.), and the PxSCH may be a PUSCH. In other aspects, the first Rx/Tx device 502 may be the network node and the second Rx/Tx device 504 may be the UE, and the PxSCH may be a PDSCH.

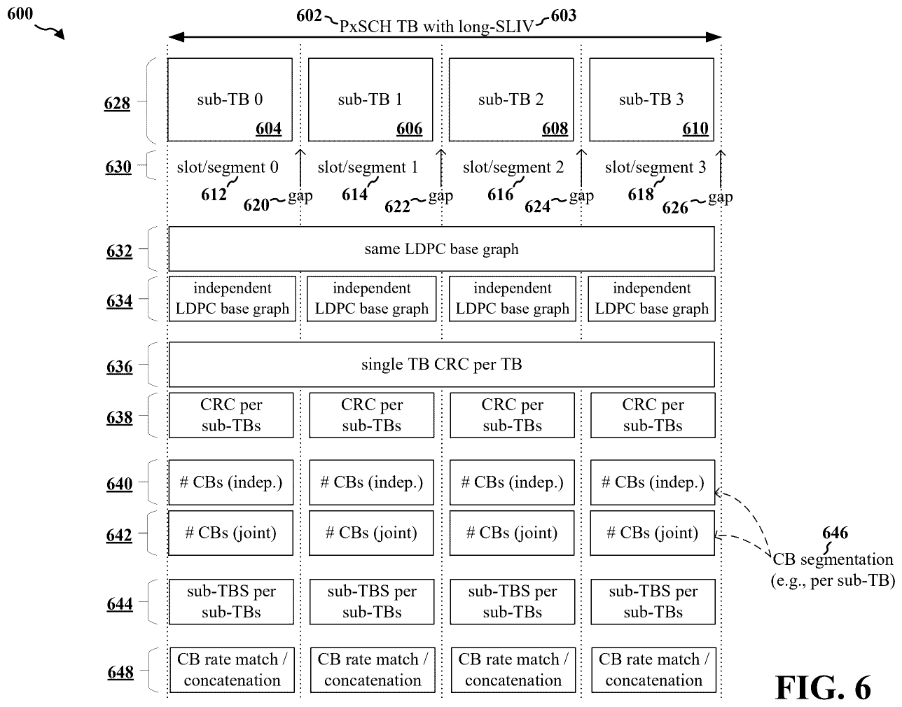

FIG. 6 is a diagram 600 illustrating an example of segmentation for a PxSCH with long-SLIV, in various aspects. The diagram 600 may be an aspect of the call flow diagram 500 in FIG. 5, and shows a set of sub-TBs 628 that comprise a PxSCH TB 602 with a long-SLIV 603. The set of sub-TBs 628 may include various numbers of sub-TBs, shown by way of example as having four sub-TBs: a sub-TB 604 in a slot/time segment 612, a sub-TB 606 in a slot/time segment 614, a sub-TB 608 in a slot/time segment 616, and a sub-TB 610 in a slot/time segment 618.

Each sub-TB in the set of sub-TBs 628 may be separated by a gap therebetween. As one example, a gap 620 may separate the sub-TB 604 and the sub-TB 606, a gap 622 may separate the sub-TB 606 and the sub-TB 608, a gap 620 may separate the sub-TB 608 and the sub-TB 610, and a gap 626 may separate the sub-TB 610 from a next sub-TB (or may come after the sub-TB 610 as the final sub-TB).

Aspects herein provide for the partitioning of the PxSCH resources into a set of time segments 630 (e.g., the slot/time segment 612, the slot/time segment 614, the slot/time segment 616, and the slot/time segment 618) by the physical/logical gaps (e.g., the gap 620, the gap 622, the gap 624, and/or the gap 626). Aspects also enable the performance of TBS/CB determinations/calculations, CB segmentation, CRC appending, rate matching, and CB concatenation independently in each time segment of the set of time segments 630.

For each time segment of the set of time segments 630, e.g., a given segment i, an Rx/Tx device, such as the first Rx/Tx device 502 in FIG. 5, may be configured to compute the available REs as N_{RE,i}, and the unquantized numbers of information bits may be represented as N_{info,i}=N_{RE,i}RQₘv, where R, Qₘ is the modulation order and v is the number of layers, which may be the same across all time segments of the set of time segments 630, according to aspects. For a given time segment, the Rx/Tx device, such as the first Rx/Tx device 502 in FIG. 5, may be configured to calculate the sub-TBS based on N_{info,i}.

In aspects, different ones of the set of time segments 630 may contain a different number of unquantized info bits, e.g., based on the PxSCH TB 602. Even when the same code rate is targeted, a NR base graph selection may be different for different time segments of the set of time segments 630 depending on whether the TBS size is in a TBS≤292 region, a 292<TBS≤3824 region, or a TBS>3824 region. This may also be based on the code rate.

Accordingly, some aspects allow for a different or the same LDPC base graph to be chosen for different time segments of the set of time segments 630. In one example, for each time segment of the set of time segments 630, different independent LDPC base graphs 634 may be chosen independently. In aspects, this may be based on the sub-TBS calculated for each time segment the set of time segments 630, as described further herein. In another example, a same LDPC base graph 632 may be chosen across the set of time segments 630 based on the minimum, the maximum, or average sub-TBS among the time segments of the set of time segments 630, as described further herein. In some aspects, for each time segment, a better/more efficient choice of base graph may be providing the independent LDPC base graphs 634 to each of the set of time segments 630, but different LDPC encoder/decoder settings may be implemented for the independent LDPC base graphs 634 in such aspects.

In some aspects, a single TB CRC 636 may be added after the TB, or a TB CRC 638 per sub-TBS may be added. In one example, a single TB CRC 636 may be added. In such aspects, this single TB CRC 636 may save signaling/payload overhead. In other aspects, a TB CRC 638 per sub-TB of the set of sub-TBs 628, or per each time segment of the set of time segments 630, may be added. As one advantage for such aspects, when combined with an ACK/NACK for each sub-TB, the associated retransmission(s) could be in the granularity of the sub-TB (e.g., at the cost of additional CRC overhead).

Regarding sub-TBS determinations/calculations, the number of CBs and a sub-TBS 644 can be obtained independently as independent numbers of CBs 640 per time segment of the set of time segments 630, or jointly as joint numbers of CBs 642, according to aspects, where each time segment of the set of time segments 630 includes at least one CB.

In one example, with reference to the different independent LDPC base graphs 634 and the same LDPC base graph 632 configurations described above, an updated number of unquantized information bits for a given time segment i may be:

$${N}_{info , i} = {N}_{info , i} ,$$

in association with the different independent LDPC base graphs 634 configuration, or may be:

$$\begin{matrix}{N}_{info , i} = {min}_{i} \{ {N}_{info , i} \} , \\ {N}_{info , i} = {max}_{i} \{ {N}_{info , i} \} , or \\ {N}_{info , i} = {mean}_{i} \{ {N}_{info , i} \}\end{matrix}$$

in association with the same LDPC base graph 632 configuration.

Based on the unquantized information bits N_{info,i} and the code rate (R), an Rx/Tx device may be configured to calculate/determine the LDPC base graph to use, the number of CBs 640/642 (Ct) and the sub-TBS 644 (TBSᵢ) in each time segment i. For example, if N_{info,i}≤3824, the Rx/Tx device may be configured to quantize N_{info,i} as:

$${N}_{info , i}^{′} = max ( 24 , {2}^{n} ⌊ \frac{{N}_{info , i}}{{2}^{n}} ⌋ ) , where n = max ( 3 , ⌊ {log}_{2} ( {N}_{info , i} ) ⌋ - 6 ) ,$$

and use a TBS table to identify/determine the closest TBSᵢ≥N_{info,i}′ and a single CB. If N_{info,i}>3824, the Rx/Tx device may be configured to quantize:

$${N}_{info , i}^{′} = max ( 3840 , {2}^{n} ⌊ \frac{{N}_{info , i} - {X}_{i}}{{2}^{n}} ⌋ ) , where n = max ( 3 , ⌊ {log}_{2} ( {N}_{info , i} - {X}_{i} ) ⌋ - 6 ) .$$

If R≤0.25, the different independent LDPC base graphs 634 may be used, the number of CBs 640/642 may be represented as:

$${C}_{i} = ⌈ \frac{{N}_{info , i}^{′} + {X}_{i}}{3816} ⌉ and {TBS}_{i} = 8 \cdot {C}_{i} \cdot ⌈ \frac{{N}_{info , i}^{′} + {X}_{i}}{8 {C}_{i}} ⌉ - 24 .$$

Otherwise, if N_{info,i}′>8424 (e.g., as for the same LDPC base graph 632), then the number of CBs 640/642 may be represented as:

$${C}_{i} = ⌈ \frac{{N}_{info , i}^{′} + {X}_{i}}{8424} ⌉ and {TBS}_{i} = 8 \cdot {C}_{i} \cdot ⌈ \frac{{N}_{info , i}^{′} + {X}_{i}}{8 {C}_{i}} ⌉ - {X}_{i} .$$

Otherwise, the number of CBs 640/642 may be represented as: C=1 (different independent LDPC base graphs 634) and

$$T B {S}_{i} = 8 \cdot {C}_{i} \cdot ⌈ \frac{{N}_{info , i}^{′} + {X}_{i}}{8 {C}_{i}} ⌉ - {X}_{i} .$$

In aspects, such as for the single TB CRC 636, Xᵢ=0, except for one of the set of sub-TBs 628 (e.g., the last one), where Xᵢ=24. In other aspects, such as for the TB CRC 638 per sub-TB of the set of sub-TBs 628, Xᵢ=24. The total TBS for the PxSCH TB 602 with the long-SLIV 603 may be the sum of the sub-TBS's in the time segments of the set of time segments 630: TBS=ΣᵢTBSᵢ.

With respect to CB segmentation 646, for each sub-TB of the set of sub-TBs 628, after the TB CRC 638 attachment (e.g., per sub-TBs), and the base graph selection (the different independent LDPC base graphs 634 or the same LDPC base graph 632), CB segmentation 646 may be applied independently by the Rx/Tx device.

For instance After TB CRC 638 attachment, the CB bits b₀, b₁, . . . , b_{B}_{ᵢ}₋₁ may be input into a CB segmentation 646 component, and an additional 24-bit CRC may be attached to each CB if the number of CBs Cᵢ>1 (e.g., for the number of CBs as independent numbers of CBs 640 per time segment of the set of time segments 630, or jointly as joint numbers of CBs 642). If the Bᵢ is greater than the maximum CB size of the selected base graph (e.g., the different independent LDPC base graphs 634 or the same LDPC base graph 632), then the number of CBs (e.g., for the number of CBs as independent numbers of CBs 640 per time segment of the set of time segments 630, or jointly as joint numbers of CBs 642) may be

$${C}_{i} = ⌈ \frac{{B}_{i}}{{K}_{c b} - L} ⌉ ,$$

and an L=24-bit CRC may be added per CB (e.g., for the number of CBs as independent numbers of CBs 640 per time segment of the set of time segments 630, or jointly as joint numbers of CBs 642), and Bᵢ′=Bᵢ+Cᵢ·L.

The bits after CB segmentation 646 may be denoted by: cᵣ₀, cᵣ₁, . . . c_{r(K}_{ᵣᵢ}₋₁₎, where r is the code block number and Kᵣᵢ is the number of bits for code block number. The number Kᵣᵢ=22Z_{c}, (e.g., for the different independent LDPC base graphs 634), or the number Kᵣᵢ=10Z_{c}, (e.g., for the same LDPC base graph 632), where Z_{ci} is the smallest lifting factor such that K_{bi}Z_{ci}≥Kᵢ′=Bᵢ′/Cᵢ (e.g., K_{bi}=22 for the same LDPC base graph 632 and K_{bi}=6, 8, 9, 10 depending on Bᵢ). In aspects, from K′ to Kr bits, filler data may be inserted.

Aspects provide for CB rate matching/concatenation 648 (e.g., a CB rate matching and an associated concatenation) to be performed per-time segment. A CB rate match of the CB rate matching/concatenation 648, e.g., per-time segment/per-sub-TB, may be performed by an Rx/Tx device, as described herein. For example, after channel coding to generate bits cᵣ₀, cᵣ₁, . . . , c_{r(K}_{ᵣᵢ}₋₁₎, LDPC channel coding may generate bits dᵣ₀, dᵣ₁, . . . , d_{r(N}_{ᵣᵢ}₋₁₎, where Nᵣᵢ=66Z_{ci} (e.g., for the different independent LDPC base graphs 634) or Nᵣᵢ=50Z_{ci} (e.g., for the same LDPC base graph 632).

In one example, the bits dᵣ₀, dᵣ₁, . . . , d_{r(N}_{ᵣᵢ}₋₁₎ described above may be provided for rate matching of the CB rate matching/concatenation 648 to generate bits fᵣ₀, fᵣ₁, . . . f_{r(E}_{ᵣᵢ}₋₁₎. The bits fᵣ₀, fᵣ₁, . . . , f_{r(E}_{ᵣᵢ}₋₁₎ may undergo CB concatenation of the CB rate matching/concatenation 648 to generate bits g₀, g₁, . . . , g_{Gi-1}. In aspects, the Rx/Tx device may be configured to compute/calculate the rate-matched bit per CB by dividing the number of coded bits by the number of CBs (e.g., for the number of CBs as independent numbers of CBs 640 per time segment of the set of time segments 630, or jointly as joint numbers of CBs 642) in a given time segment i of the set of time segments 630 (e.g., Eᵣᵢ is the number of rate matched bits for a CB ri, and

$${E}_{r i} = {N}_{L} {Q}_{m} ⌈ \frac{{G}_{i}}{{N}_{L} {Q}_{m} {C}_{i}^{′}} ⌉ ) .$$

In aspects, the last CB may not be rate matched if not evenly divisible.

In some aspects, Cᵢ′=Cᵢ, e.g., if CBG transmission information (CBGTI) is not present. In some aspects, Gᵢ is the total number of coded bits available that can be transmitted in the time segment i. The Nri CB bits from a CB r in a time segment i may be rate-matched to Eri bits of resources, according to aspects, and the CB concatenation of the CB rate matching/concatenation 648 may be performed for a time segment i to obtain the concatenated bits g₀, g₁, . . . , g_{Gi-1}.

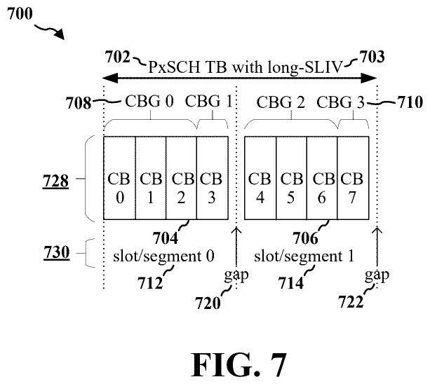

FIG. 7 is a diagram 700 illustrating an example of a CBG configuration for a PxSCH with long-SLIV, in various aspects. The diagram 700 may be an aspect of the call flow diagram 500 in FIG. 5, and shows respective sets of CBGs for time segments: e.g., a set of CBGs 708 (e.g., including a CBG 0 and a CBG 1) and a set of CBGs 710 (e.g., including a CBG 2 and a CBG 3).

For example, a set of sub-TBs 728 that comprise a PxSCH TB 702 with a long-SLIV 703 are shown, and the set of sub-TBs 728 may include various numbers of sub-TBs, shown by way of example as having two sub-TBs: a sub-TB 704 in a slot/time segment 712 and a sub-TB 706 in a slot/time segment 714. Each sub-TB in the set of sub-TBs 728 may be separated by a gap therebetween. As one example, a gap 720 may separate the sub-TB 704 and the sub-TB 706, and a gap 722 may separate the sub-TB 706 from a next sub-TB (or may come after the sub-TB 706 as the final sub-TB).

As noted above, aspects herein provide for the partitioning of PxSCH resources into a set of time segments 730 (e.g., the slot/time segment 712, the slot/time segment 714) by the physical/logical gaps (e.g., the gap 720, the gap 722). In 5G NR, when a CBG is configured, a fixed number of CBs are grouped into a single CBG group, and an ACK/NACK bit may be associated with one CBG group to allow per-CBG retransmission. For long-SLIV with gaps, assuming a CB does not cross a gap, it may be acceptable to have any given CBG group to be within one time segment as the interference experienced may be different after a gap.

Accordingly, aspects herein support configurations such that CBG(s) (e.g., the set of CBGs 708 (including the CBG 0 and the CBG 1) and the set of CBGs 710 (including the CBG 2 and the CBG 3) are fully within one time segment (e.g., CBs of the set of CBGs 708 are within the slot/time segment 712 for the sub-TB 704 and CBs of the set of CBGs 710 are within the slot/time segment 714 for the sub-TB 706). In aspects, the grouping of the CBs may be performed by an Rx/Tx device per-time segment, and the number of CBs for a given CBG in each time segment may be configured per-time segment. In aspects, the number of CBs in a given CBG may be the same or different across different time segments. In some aspects, where there may be a single CBG per each time segment, there may be a single ACK/NACK per sub-TB in the set of sub-TBs 728 within respective time segment.

In some aspects, if the number of CBs within a single time segment of the set of time segments 730 cannot divide evenly into the configured size for a CBG of the set of CBGs 708 or of the set of CBGs 710 (e.g., the CBG 0, the CBG 1, the CBG 2, the CBG 3), the remaining CBs in such a time segment may be grouped as one CBG.

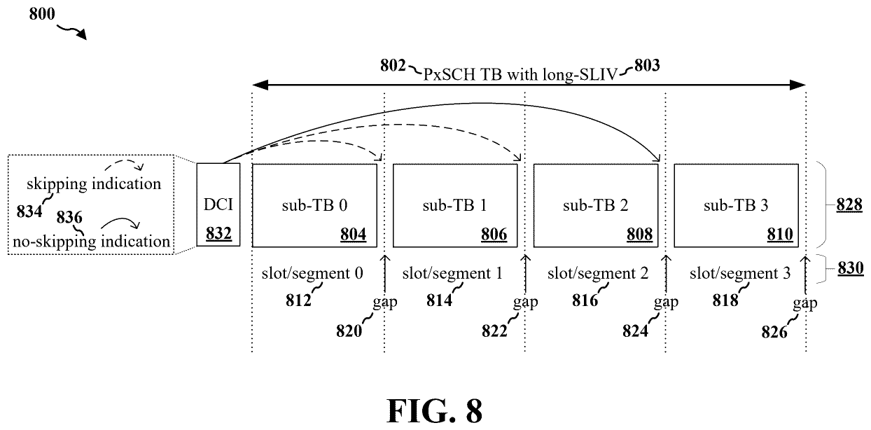

FIG. 8 is a diagram 800 illustrating an example of DCI gap skipping for a PxSCH with long-SLIV, in various aspects. The diagram 800 may be an aspect of the call flow diagram 500 in FIG. 5, and shows DCI 832 for configurations in which a gap is to be skipped for a PxSCH 802 with a long-SLIV 803.

Diagram 800 shows a set of sub-TBs 828 that comprise the PxSCH TB 602 with the long-SLIV 803. The set of sub-TBs 828 may include various numbers of sub-TBs, shown by way of example as having four sub-TBs: a sub-TB 804 in a slot/time segment 812, a sub-TB 806 in a slot/time segment 814, a sub-TB 808 in a slot/time segment 816, and a sub-TB 810 in a slot/time segment 818.

Each sub-TB in the set of sub-TBs 828 may be separated by a gap therebetween. As one example, a gap 820 may separate the sub-TB 804 and the sub-TB 806, a gap 822 may separate the sub-TB 806 and the sub-TB 808, a gap 820 may separate the sub-TB 808 and the sub-TB 810, and a gap 826 may separate the sub-TB 810 from a next sub-TB (or may come after the sub-TB 810 as the final sub-TB).

As noted, aspects herein provide for the partitioning of the PxSCH 802 resources into a set of time segments 830 (e.g., the slot/time segment 812, the slot/time segment 814, the slot/time segment 816, and the slot/time segment 818) by the physical/logical gaps (e.g., the gap 820, the gap 822, the gap 824, and/or the gap 826). Aspects also provide for dynamic indications of gaps and enable the DCI 832 to indicate dynamic skipping, or no skipping, for gaps (e.g., the gap 820, the gap 822, the gap 824, and/or the gap 826) when allocating TB(s) (and/or the set of sub-TBs 828) across the long-SLIV 603 time span. In aspects, the DCI 832 and/or such allocation may be configured by a second Rx/Tx device (e.g., a base station, a gNB, etc.), and such allocations may be associated with the skipping of gaps for TB/CB segmentation or may directly indicate a given gap for the TB/CB segmentation.

In aspects, UL gaps or TTI-to-TTI gaps may be derived from TDD frame structure signaling, e.g., RRC signaling for a TDD configuration, SFI, etc. The DCI 832 may indicate (e.g., by a skipping indication 834) which physical gap(s) within the long-SLIV 803 time span to be skipped for TB/CB segmentation. In some aspects, the DCI 832 may indicate (e.g., by a no-skipping indication 836) which physical gap(s) within the long-SLIV 803 time span are not to be skipped for TB/CB segmentation. In aspects, the skipping indication 834 and/or the no-skipping indication 836 may be indicated utilizing a bitmap where each bit thereof is mapped to one physical gap (e.g., of the gap 820, the gap 822, the gap 824, and/or the gap 826).

In some aspects, the DCI 832 may directly indicate the gap boundary in the long-SLIV 803 time span. Such an indication may be table-based, where possible gap patterns are enumerated in the table, and the entry index of the associated gap is indicated by the DCI 832 (e.g., as the skipping indication 834 and/or the no-skipping indication 836). In aspects, such possible gap patterns may be derived from the TDD frame structure.

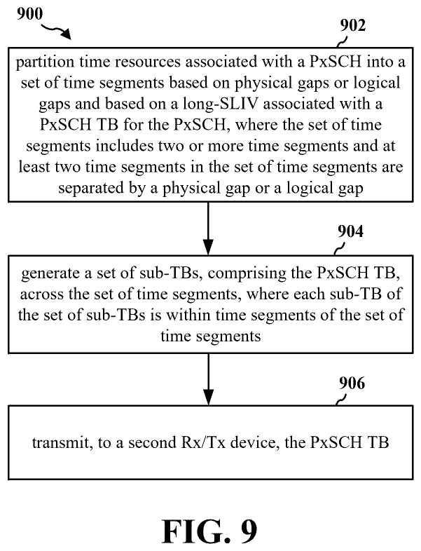

FIG. 9 is a flowchart 900 of a method of wireless communication. The method may be performed by a first Rx/Tx device such as a UE (e.g., the UE 104; the apparatus 1104) or a network node (e.g., the base station 102; the network entity 1102, 1202). The method may be for PxSCH TBS and CBs for long-SLIV with gaps. The method may provide for enabling non-contiguous time-domain resources for a PxSCH intervened by one or more time gaps, where a TB is split into multiple sub-TBs across the gaps, and each sub-TB may be treated separately for sub-TBS calculation(s), CRC adding, and/or CBG segmentation, or alternatively treated jointly, as well as enabling self-contained CBGs per sub-TB and dynamic indication of the gap(s).

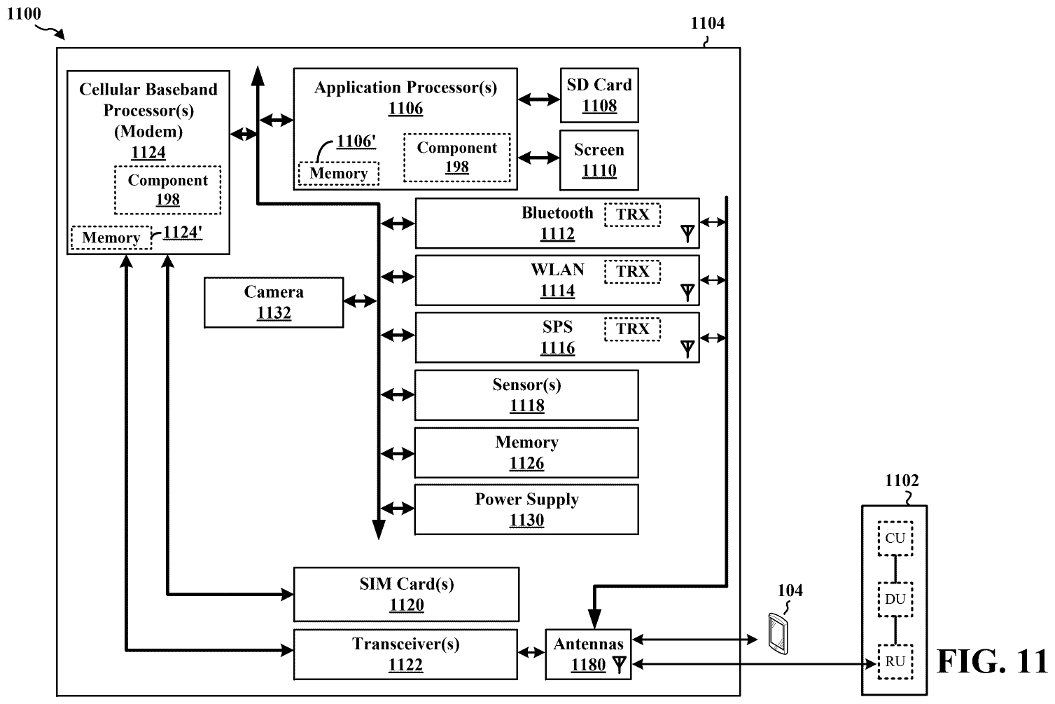

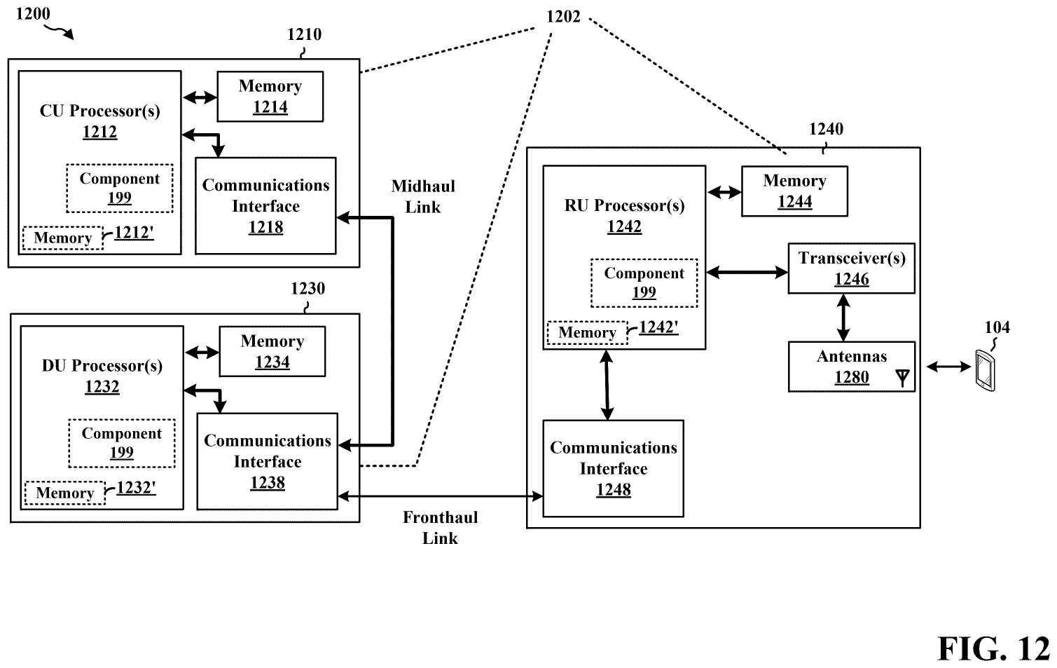

At 902, the first Rx/Tx device partitions time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. As an example, the partitioning may be performed by one or more of the component 198, the transceiver(s) 1122, and/or the antennas 1180 in FIG. 11. As another example, the partitioning may be performed by one or more of the component 199, the transceiver(s) 1246, and/or the antennas 1280 in FIG. 12. FIG. 5 illustrates, in the context of FIGS. 6-9, an example of the first Rx/Tx device 502 partitioning such time resources.

The first Rx/Tx device 502 may be configured to receive, and the second Rx/Tx device 504 may be configured to transmit/provide, DCI 506 (e.g., 832 in FIG. 8). The DCI 506 (e.g., 832 in FIG. 8) may be indicative of a skip (e.g., 834, 836 in FIG. in FIG. 8) for a gap(s) (e.g., 620, 622, 624, 626 in FIG. 6; 720, 722 in FIG. 7; 820, 822, 824, 826 in FIG. 8). The gap(s) (e.g., 620, 622, 624, 626 in FIG. 6; 720, 722 in FIG. 7; 820, 822, 824, 826 in FIG. 8) may be at least one physical gap or at least one logical gap. In aspects, the skip (e.g., 834, 836 in FIG. in FIG. 8) may be associated with a TB segmentation (e.g., 612, 614, 616, 618 in FIG. 6; 712, 714 in FIG. 7; 812, 814, 816, 818 in FIG. 8) or a CB segmentation (e.g., 646 in FIG. 6) and in accordance with an interference correlation for sub-TBs (e.g., 604, 606, 608, 610 in FIG. 6; 704, 706 in FIG. 7; 804, 806, 808, 810 in FIG. 8) separated by the at least one physical gap (e.g., 620, 622, 624, 626 in FIG. 6; 720, 722 in FIG. 7; 820, 822, 824, 826 in FIG. 8) or the at least one logical gap (e.g., 620, 622, 624, 626 in FIG. 6; 720, 722 in FIG. 7; 820, 822, 824, 826 in FIG. 8). In some aspects, the DCI 506 (e.g., 832 in FIG. 8) may indicate the logical gap(s) (e.g., 620, 622, 624, 626 in FIG. 6; 720, 722 in FIG. 7; 820, 822, 824, 826 in FIG. 8) as an uplink gap or a transmission time interval (TTI) to TTI (TTI-to-TTI) gap associated with a TDD frame structure in at least one of RRC signaling or a slot format indication (SFI). In aspects, such RRC signaling or SFI may be provided to the first Rx/Tx device 502 (e.g., as a UE) from the second Rx/Tx device (e.g., as a base station, gNB, etc.). In other aspects, the DCI 506 (e.g., 832 in FIG. 8) may identify a physical gap(s) (e.g., 620, 622, 624, 626 in FIG. 6; 720, 722 in FIG. 7; 820, 822, 824, 826 in FIG. 8) for the skip (e.g., 834, 836 in FIG. in FIG. 8). In aspects, the DCI 506 (e.g., 832 in FIG. 8) may indicate the physical gap(s) and/or the logical gap(s) (e.g., 620, 622, 624, 626 in FIG. 6; 720, 722 in FIG. 7; 820, 822, 824, 826 in FIG. 8) by a reference to a data structure associated with enumerated gap patterns. In aspects, the DCI 506 (e.g., 832 in FIG. 8) may indicate the physical gap(s) and/or the logical gap(s) (e.g., 620, 622, 624, 626 in FIG. 6; 720, 722 in FIG. 7; 820, 822, 824, 826 in FIG. 8) by an association with a TDD frame structure.

The first Rx/Tx device 502 may be configured to partition (at 508) time resources associated with a PxSCH into a set of time segments (e.g., 630 in FIG. 6; e.g., 730 in FIG. 7; 830 in FIG. 8) based on physical gaps or logical gaps (e.g., 620, 622, 624, 626 in FIG. 6; 720, 722 in FIG. 7; 820, 822, 824, 826 in FIG. 8) and based on a long-SLIV (e.g., 603 in FIG. 6; 703 in FIG. 7; 803 in FIG. 8) associated with a PxSCH TB 512 (e.g., 602 in FIG. 6; 702 in FIG. 7; 802 in FIG. 8) for the PxSCH. The set of time segments (e.g., 630 in FIG. 6; e.g., 730 in FIG. 7; 830 in FIG. 8) may include two or more time segments (e.g., 612, 614, 616, 618 in FIG. 6; 712, 714 in FIG. 7; 812, 814, 816, 818 in FIG. 8) and at least two time segments (e.g., 612, 614, 616, 618 in FIG. 6; 712, 714 in FIG. 7; 812, 814, 816, 818 in FIG. 8) in the set of time segments (e.g., 630 in FIG. 6; e.g., 730 in FIG. 7; 830 in FIG. 8) are separated by a gap (e.g., a physical gap or a logical gap (e.g., 620, 622, 624, 626 in FIG. 6; 720, 722 in FIG. 7; 820, 822, 824, 826 in FIG. 8)). In some aspects, the PxSCH TB 512 (e.g., 602 in FIG. 6; 702 in FIG. 7; 802 in FIG. 8) may include a set of CBs, and each CB of the set of CBs may be within one of the set of time segments (e.g., 630 in FIG. 6; e.g., 730 in FIG. 7; 830 in FIG. 8).

The time resources may have time resource characteristics that may include a per-segment association for the set of time segments (e.g., 630 in FIG. 6; e.g., 730 in FIG. 7; 830 in FIG. 8). In aspects, the time resource characteristics may include a sub-TB size (sub-TBS) (e.g., 644 in FIG. 6) of each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8), each CB of the set of CBs (e.g., 640, 642 in FIG. 6), a CB segmentation (e.g., 646 in FIG. 6), a cyclic redundancy check (CRC) (e.g., 636, 638 in FIG. 6), a rate matching (e.g., 648 in FIG. 6), a CB concatenation (e.g., 648 in FIG. 6), and/or the like. In some aspects, the time resource characteristics, for each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8), may be based on a number of available REs and/or a number of unquantized information bits in each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). In such aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may have a same modulation order and a same number of layers.

At 904, the first Rx/Tx device generates a set of sub-TBs, comprising the PxSCH TB, across the set of time segments, where each sub-TB of the set of sub-TBs is within time segments of the set of time segments. As an example, the generation may be performed by one or more of the component 198, the transceiver(s) 1122, and/or the antennas 1180 in FIG. 11. As another example, the generation may be performed by one or more of the component 199, the transceiver(s) 1246, and/or the antennas 1280 in FIG. 12. FIG. 5 illustrates, in the context of FIGS. 6-9, an example of the first Rx/Tx device 502 generating such a set of sub-TBs across a set of time segments.

The first Rx/Tx device 502 may be configured to generate (at 510) a set of sub-TBs (e.g., 628 in FIG. 6; 728 in FIG. 7; 828 in FIG. 8), comprising the PxSCH TB 512 (e.g., 602 in FIG. 6; 702 in FIG. 7; 802 in FIG. 8), across the set of time segments (e.g., 630 in FIG. 6; e.g., 730 in FIG. 7; 830 in FIG. 8). Each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8) may be within time segments (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). In aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may be associated with a respective low density parity check (LDPC) base graph (e.g., 634 in FIG. 6) based on the sub-TBS (e.g., 644 in FIG. 6) of each time segment (e.g., 604, 606, 608, 610 in FIG. 6; 704, 706 in FIG. 7; 804, 806, 808, 810 in FIG. 8). In other aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may be associated with a same LDPC base graph (e.g., 632 in FIG. 6) based on at least one of a minimum sub-TBS, a maximum sub-TBS, or an average sub-TBS (e.g., 644 in FIG. 6) over the set of time segments (e.g., 630 in FIG. 6; e.g., 730 in FIG. 7; 830 in FIG. 8). In either of such aspects, each time segment (e.g., 612, 614, 616, 618 in FIG. 6; 712, 714 in FIG. 7; 812, 814, 816, 818 in FIG. 8) may include at least one CB (e.g., a set of CBs), a number of CBs (e.g., 640, 642 in FIG. 6) in the set of CBs, and a number of sub-TBs in the set of sub-TBs (e.g., 628 in FIG. 6; 728 in FIG. 7; 828 in FIG. 8), may be based on a number of unquantized information bits in each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). This may be configured for each time segment (e.g., 612, 614, 616, 618 in FIG. 6; 712, 714 in FIG. 7; 812, 814, 816, 818 in FIG. 8) individually (e.g., 640 in FIG. 6) or for the set of time segments (e.g., 630 in FIG. 6; e.g., 730 in FIG. 7; 830 in FIG. 8) jointly (e.g., 642 in FIG. 6).

In aspects, the CRC may include a single CRC (e.g., 636 in FIG. 6) associated with the PxSCH TB 512 (e.g., 602 in FIG. 6; 702 in FIG. 7; 802 in FIG. 8), while in other aspects the CRC may include a set of sub-CRCs (e.g., 638 in FIG. 6) associated with each sub-TB (e.g., 604, 606, 608, 610 in FIG. 6; 704, 706 in FIG. 7; 804, 806, 808, 810 in FIG. 8) or associated with each time segment (e.g., 612, 614, 616, 618 in FIG. 6; 712, 714 in FIG. 7; 812, 814, 816, 818 in FIG. 8) in the set of time segments (e.g., 630 in FIG. 6; e.g., 730 in FIG. 7; 830 in FIG. 8). In such aspects, each sub-CRC in the set of sub-CRCs may be associated with at least one of an ACK/NACK or a retransmission having a per-sub-TB granularity.

In some aspects, the CB segmentation (e.g., 646 in FIG. 6) may be associated with each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8), subsequent to an application of the CRC (e.g., 636, 638 in FIG. 6) and a respective low density parity check (LDPC) base graph selection (e.g., 632, 634 in FIG. 6), in accordance with a CB number for each CB in the set of CBs (e.g., 640, 642 in FIG. 6) and a number of bits for each CB number. In some aspects, the rate matching and/or the CB concatenation (e.g., 648 in FIG. 6) may be associated with each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) and may be based on a ratio of a number of coded bits for a channel coding to a number of CBs (e.g., 640, 642 in FIG. 6) in a respective time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8).

In aspects, at least one time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) includes a respective set of CB groups (CBGs) (e.g., 708, 710 in FIG. 7). In such aspects, each respective set of CBGs e.g., 708, 710 in FIG. 7) may include a number of CBs (e.g., 640, 642 in FIG. 6) of the set of CBs e.g., 708, 710 in FIG. 7) and is within a respective time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). The number of CBs (e.g., 640, 642 in FIG. 6) in each CBG of each respective set of CBGs e.g., 708, 710 in FIG. 7) may be based on a per-time segment configuration for the at least one time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8).

At 906, the first Rx/Tx device transmits, to a second Rx/Tx device, the PxSCH TB. As an example, the transmission/provision may be performed by one or more of the component 198, the transceiver(s) 1122, and/or the antennas 1180 in FIG. 11. As another example, the transmission/provision may be performed by one or more of the component 199, the transceiver(s) 1246, and/or the antennas 1280 in FIG. 12. FIG. 5 illustrates, in the context of FIGS. 6-9, an example of the first Rx/Tx device 502 the transmitting/providing such a PxSCH TB to the second Rx/Tx device 504.

The first Rx/Tx device 502 may be configured to transmit/provide, and the second Rx/Tx device 504 may be configured to receive, the PxSCH TB 512 (e.g., 602 in FIG. 6; 702 in FIG. 7; 802 in FIG. 8). In some aspects, the first Rx/Tx device 502 may be a UE and the second Rx/Tx device 504 may be a network node (e.g., a base station, gNB, etc.), and the PxSCH may be a PUSCH. In other aspects, the first Rx/Tx device 502 may be the network node and the second Rx/Tx device 504 may be the UE, and the PxSCH may be a PDSCH.

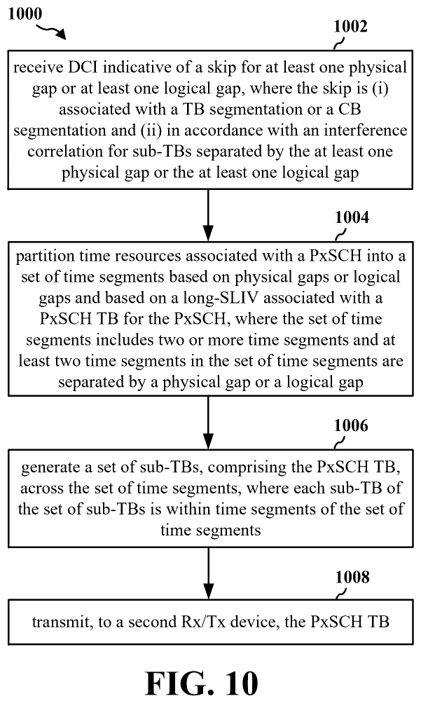

FIG. 10 is a flowchart 1000 of a method of wireless communication. The method may be performed by a first Rx/Tx device such as a UE (e.g., the UE 104; the apparatus 1104) or a network node (e.g., the base station 102; the network entity 1102, 1202). The method may be for PxSCH TBS and CBs for long-SLIV with gaps. The method may provide for enabling non-contiguous time-domain resources for a PxSCH intervened by one or more time gaps, where a TB is split into multiple sub-TBs across the gaps, and each sub-TB may be treated separately for sub-TBS calculation(s), CRC adding, and/or CBG segmentation, or alternatively treated jointly, as well as enabling self-contained CBGs per sub-TB and dynamic indication of the gap(s).

At 1002, the first Rx/Tx device receives DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. As an example, the reception may be performed by one or more of the component 198, the transceiver(s) 1122, and/or the antennas 1180 in FIG. 11. FIG. 5 illustrates, in the context of FIGS. 6-9, an example of the first Rx/Tx device 502 the receiving such DCI from the second Rx/Tx device 504.

The first Rx/Tx device 502 may be configured to receive, and the second Rx/Tx device 504 may be configured to transmit/provide, DCI 506 (e.g., 832 in FIG. 8). The DCI 506 (e.g., 832 in FIG. 8) may be indicative of a skip (e.g., 834, 836 in FIG. in FIG. 8) for a gap(s) (e.g., 620, 622, 624, 626 in FIG. 6; 720, 722 in FIG. 7; 820, 822, 824, 826 in FIG. 8). The gap(s) (e.g., 620, 622, 624, 626 in FIG. 6; 720, 722 in FIG. 7; 820, 822, 824, 826 in FIG. 8) may be at least one physical gap or at least one logical gap. In aspects, the skip (e.g., 834, 836 in FIG. in FIG. 8) may be associated with a TB segmentation (e.g., 612, 614, 616, 618 in FIG. 6; 712, 714 in FIG. 7; 812, 814, 816, 818 in FIG. 8) or a CB segmentation (e.g., 646 in FIG. 6) and in accordance with an interference correlation for sub-TBs (e.g., 604, 606, 608, 610 in FIG. 6; 704, 706 in FIG. 7; 804, 806, 808, 810 in FIG. 8) separated by the at least one physical gap (e.g., 620, 622, 624, 626 in FIG. 6; 720, 722 in FIG. 7; 820, 822, 824, 826 in FIG. 8) or the at least one logical gap (e.g., 620, 622, 624, 626 in FIG. 6; 720, 722 in FIG. 7; 820, 822, 824, 826 in FIG. 8). In some aspects, the DCI 506 (e.g., 832 in FIG. 8) may indicate the logical gap(s) (e.g., 620, 622, 624, 626 in FIG. 6; 720, 722 in FIG. 7; 820, 822, 824, 826 in FIG. 8) as an uplink gap or a transmission time interval (TTI) to TTI (TTI-to-TTI) gap associated with a TDD frame structure in at least one of RRC signaling or a slot format indication (SFI). In aspects, such RRC signaling or SFI may be provided to the first Rx/Tx device 502 (e.g., as a UE) from the second Rx/Tx device (e.g., as a base station, gNB, etc.). In other aspects, the DCI 506 (e.g., 832 in FIG. 8) may identify a physical gap(s) (e.g., 620, 622, 624, 626 in FIG. 6; 720, 722 in FIG. 7; 820, 822, 824, 826 in FIG. 8) for the skip (e.g., 834, 836 in FIG. in FIG. 8). In aspects, the DCI 506 (e.g., 832 in FIG. 8) may indicate the physical gap(s) and/or the logical gap(s) (e.g., 620, 622, 624, 626 in FIG. 6; 720, 722 in FIG. 7; 820, 822, 824, 826 in FIG. 8) by a reference to a data structure associated with enumerated gap patterns. In aspects, the DCI 506 (e.g., 832 in FIG. 8) may indicate the physical gap(s) and/or the logical gap(s) (e.g., 620, 622, 624, 626 in FIG. 6; 720, 722 in FIG. 7; 820, 822, 824, 826 in FIG. 8) by an association with a TDD frame structure.

At 1004, the first Rx/Tx device partitions time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. As an example, the partitioning may be performed by one or more of the component 198, the transceiver(s) 1122, and/or the antennas 1180 in FIG. 11. As another example, the partitioning may be performed by one or more of the component 199, the transceiver(s) 1246, and/or the antennas 1280 in FIG. 12. FIG. 5 illustrates, in the context of FIGS. 6-9, an example of the first Rx/Tx device 502 partitioning such time resources.

The first Rx/Tx device 502 may be configured to partition (at 508) time resources associated with a PxSCH into a set of time segments (e.g., 630 in FIG. 6; e.g., 730 in FIG. 7; 830 in FIG. 8) based on physical gaps or logical gaps (e.g., 620, 622, 624, 626 in FIG. 6; 720, 722 in FIG. 7; 820, 822, 824, 826 in FIG. 8) and based on a long-SLIV (e.g., 603 in FIG. 6; 703 in FIG. 7; 803 in FIG. 8) associated with a PxSCH TB 512 (e.g., 602 in FIG. 6; 702 in FIG. 7; 802 in FIG. 8) for the PxSCH. The set of time segments (e.g., 630 in FIG. 6; e.g., 730 in FIG. 7; 830 in FIG. 8) may include two or more time segments (e.g., 612, 614, 616, 618 in FIG. 6; 712, 714 in FIG. 7; 812, 814, 816, 818 in FIG. 8) and at least two time segments (e.g., 612, 614, 616, 618 in FIG. 6; 712, 714 in FIG. 7; 812, 814, 816, 818 in FIG. 8) in the set of time segments (e.g., 630 in FIG. 6; e.g., 730 in FIG. 7; 830 in FIG. 8) are separated by a gap (e.g., a physical gap or a logical gap (e.g., 620, 622, 624, 626 in FIG. 6; 720, 722 in FIG. 7; 820, 822, 824, 826 in FIG. 8)). In some aspects, the PxSCH TB 512 (e.g., 602 in FIG. 6; 702 in FIG. 7; 802 in FIG. 8) may include a set of CBs, and each CB of the set of CBs may be within one of the set of time segments (e.g., 630 in FIG. 6; e.g., 730 in FIG. 7; 830 in FIG. 8).

The time resources may have time resource characteristics that may include a per-segment association for the set of time segments (e.g., 630 in FIG. 6; e.g., 730 in FIG. 7; 830 in FIG. 8). In aspects, the time resource characteristics may include a sub-TB size (sub-TBS) (e.g., 644 in FIG. 6) of each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8), each CB of the set of CBs (e.g., 640, 642 in FIG. 6), a CB segmentation (e.g., 646 in FIG. 6), a cyclic redundancy check (CRC) (e.g., 636, 638 in FIG. 6), a rate matching (e.g., 648 in FIG. 6), a CB concatenation (e.g., 648 in FIG. 6), and/or the like. In some aspects, the time resource characteristics, for each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8), may be based on a number of available REs and/or a number of unquantized information bits in each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). In such aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may have a same modulation order and a same number of layers.

At 1006, the first Rx/Tx device generates a set of sub-TBs, comprising the PxSCH TB, across the set of time segments, where each sub-TB of the set of sub-TBs is within time segments of the set of time segments. As an example, the generation may be performed by one or more of the component 198, the transceiver(s) 1122, and/or the antennas 1180 in FIG. 11. As another example, the generation may be performed by one or more of the component 199, the transceiver(s) 1246, and/or the antennas 1280 in FIG. 12. FIG. 5 illustrates, in the context of FIGS. 6-9, an example of the first Rx/Tx device 502 generating such a set of sub-TBs across a set of time segments.

The first Rx/Tx device 502 may be configured to generate (at 510) a set of sub-TBs (e.g., 628 in FIG. 6; 728 in FIG. 7; 828 in FIG. 8), comprising the PxSCH TB 512 (e.g., 602 in FIG. 6; 702 in FIG. 7; 802 in FIG. 8), across the set of time segments (e.g., 630 in FIG. 6; e.g., 730 in FIG. 7; 830 in FIG. 8). Each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8) may be within time segments (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). In aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may be associated with a respective low density parity check (LDPC) base graph (e.g., 634 in FIG. 6) based on the sub-TBS (e.g., 644 in FIG. 6) of each time segment (e.g., 604, 606, 608, 610 in FIG. 6; 704, 706 in FIG. 7; 804, 806, 808, 810 in FIG. 8). In other aspects, each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) may be associated with a same LDPC base graph (e.g., 632 in FIG. 6) based on at least one of a minimum sub-TBS, a maximum sub-TBS, or an average sub-TBS (e.g., 644 in FIG. 6) over the set of time segments (e.g., 630 in FIG. 6; e.g., 730 in FIG. 7; 830 in FIG. 8). In either of such aspects, each time segment (e.g., 612, 614, 616, 618 in FIG. 6; 712, 714 in FIG. 7; 812, 814, 816, 818 in FIG. 8) may include at least one CB (e.g., a set of CBs), a number of CBs (e.g., 640, 642 in FIG. 6) in the set of CBs, and a number of sub-TBs in the set of sub-TBs (e.g., 628 in FIG. 6; 728 in FIG. 7; 828 in FIG. 8), may be based on a number of unquantized information bits in each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). This may be configured for each time segment (e.g., 612, 614, 616, 618 in FIG. 6; 712, 714 in FIG. 7; 812, 814, 816, 818 in FIG. 8) individually (e.g., 640 in FIG. 6) or for the set of time segments (e.g., 630 in FIG. 6; e.g., 730 in FIG. 7; 830 in FIG. 8) jointly (e.g., 642 in FIG. 6).

In aspects, the CRC may include a single CRC (e.g., 636 in FIG. 6) associated with the PxSCH TB 512 (e.g., 602 in FIG. 6; 702 in FIG. 7; 802 in FIG. 8), while in other aspects the CRC may include a set of sub-CRCs (e.g., 638 in FIG. 6) associated with each sub-TB (e.g., 604, 606, 608, 610 in FIG. 6; 704, 706 in FIG. 7; 804, 806, 808, 810 in FIG. 8) or associated with each time segment (e.g., 612, 614, 616, 618 in FIG. 6; 712, 714 in FIG. 7; 812, 814, 816, 818 in FIG. 8) in the set of time segments (e.g., 630 in FIG. 6; e.g., 730 in FIG. 7; 830 in FIG. 8). In such aspects, each sub-CRC in the set of sub-CRCs may be associated with at least one of an ACK/NACK or a retransmission having a per-sub-TB granularity.

In some aspects, the CB segmentation (e.g., 646 in FIG. 6) may be associated with each sub-TB (e.g., 604, 606, 608, 610 in FIG. 6; 704, 706 in FIG. 7; 804, 806, 808, 810 in FIG. 8) of the set of sub-TBs (e.g., 628 in FIG. 6; 728 in FIG. 7; 828 in FIG. 8), subsequent to an application of the CRC (e.g., 636, 638 in FIG. 6) and a respective low density parity check (LDPC) base graph selection (e.g., 632, 634 in FIG. 6), in accordance with a CB number for each CB in the set of CBs (e.g., 640, 642 in FIG. 6) and a number of bits for each CB number. In some aspects, the rate matching and/or the CB concatenation (e.g., 648 in FIG. 6) may be associated with each time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) and may be based on a ratio of a number of coded bits for a channel coding to a number of CBs (e.g., 640, 642 in FIG. 6) in a respective time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8).

In aspects, at least one time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8) includes a respective set of CB groups (CBGs) (e.g., 708, 710 in FIG. 7). In such aspects, each respective set of CBGs e.g., 708, 710 in FIG. 7) may include a number of CBs (e.g., 640, 642 in FIG. 6) of the set of CBs e.g., 708, 710 in FIG. 7) and is within a respective time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8). The number of CBs (e.g., 640, 642 in FIG. 6) in each CBG of each respective set of CBGs e.g., 708, 710 in FIG. 7) may be based on a per-time segment configuration for the at least one time segment (e.g., 612, 614, 616, 618 in FIG. 6; 712, 714 in FIG. 7; 812, 814, 816, 818 in FIG. 8) of the set of time segments (e.g., 630 in FIG. 6; e.g., 730 in FIG. 7; 830 in FIG. 8).

At 1008, the first Rx/Tx device transmits, to a second Rx/Tx device, the PxSCH TB. As an example, the transmission/provision may be performed by one or more of the component 198, the transceiver(s) 1122, and/or the antennas 1180 in FIG. 11. As another example, the transmission/provision may be performed by one or more of the component 199, the transceiver(s) 1246, and/or the antennas 1280 in FIG. 12. FIG. 5 illustrates, in the context of FIGS. 6-9, an example of the first Rx/Tx device 502 the transmitting/providing such a PxSCH TB to the second Rx/Tx device 504.

The first Rx/Tx device 502 may be configured to transmit/provide, and the second Rx/Tx device 504 may be configured to receive, the PxSCH TB 512 (e.g., 602 in FIG. 6; 702 in FIG. 7; 802 in FIG. 8). In some aspects, the first Rx/Tx device 502 may be a UE and the second Rx/Tx device 504 may be a network node (e.g., a base station, gNB, etc.), and the PxSCH may be a PUSCH. In other aspects, the first Rx/Tx device 502 may be the network node and the second Rx/Tx device 504 may be the UE, and the PxSCH may be a PDSCH.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to partition time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The component 198 may also be configured to generate a set of sub-TBs, comprising the PxSCH TB, across the set of time segments, where each sub-TB of the set of sub-TBs is within a time segment of the set of time segments. The component 198 may also be configured to transmit, to a second Rx/Tx device, the PxSCH TB. The component 198 may also be configured to receive, via the least one transceiver, DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. The component 198 may be further configured to perform any of the aspects described in connection with the flowcharts in any of FIGS. 9, 10, and/or any of the aspects performed by a UE for any of FIGS. 4-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for partitioning time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. In one configuration, the apparatus 1104, and in particular the cellular baseband processor(s) 1124 and/or the application processor(s) 1106, may include means for generating a set of sub-TBs, comprising the PxSCH TB, across the set of time segments, where each sub-TB of the set of sub-TBs is within a time segment of the set of time segments. In one configuration, the apparatus 1104, and in particular the cellular baseband processor(s) 1124 and/or the application processor(s) 1106, may include means for transmitting, to a second Rx/Tx device, the PxSCH TB. In one configuration, the apparatus 1104, and in particular the cellular baseband processor(s) 1124 and/or the application processor(s) 1106, may include means for receiving DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to partition time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. The component 199 may also be configured to generate a set of sub-TBs, comprising the PxSCH TB, across the set of time segments, where each sub-TB of the set of sub-TBs is within a time segment of the set of time segments. The component 199 may also be configured to transmit, to a second Rx/Tx device, the PxSCH TB. The component 199 may also be configured to receive, via the least one transceiver, DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. The component 199 may be further configured to perform any of the aspects described in connection with the flowcharts in any of FIGS. 9, 10, and/or any of the aspects performed by a network node/entity for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for partitioning time resources associated with a PxSCH into a set of time segments based on physical gaps or logical gaps and based on a long-SLIV associated with a PxSCH TB for the PxSCH, where the set of time segments includes two or more time segments and at least two time segments in the set of time segments are separated by a physical gap or a logical gap. In one configuration, the network entity 1202 may include means for generating a set of sub-TBs, comprising the PxSCH TB, across the set of time segments, where each sub-TB of the set of sub-TBs is within a time segment of the set of time segments. In one configuration, the network entity 1202 may include means for transmitting, to a second Rx/Tx device, the PxSCH TB. In one configuration, the network entity 1202 may include means for receiving, via the least one transceiver, DCI indicative of a skip for at least one physical gap or at least one logical gap, where the skip is (i) associated with a TB segmentation or a CB segmentation and (ii) in accordance with an interference correlation for sub-TBs separated by the at least one physical gap or the at least one logical gap. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A UE in a wireless communication network may communicate in various configurations and using various communication schema with a network node utilizing a PxSCH.” A repeated PxSCH transmission (e.g., a PUSCH) with multiple segments of back-to-back symbols may be utilized to extend the PxSCH coverage. However, such repetitions may take different RVs of the PxSCH, and each repetition segment is configured to not cross the slot boundary in current solutions. Additional issues with repeated PxSCH transmissions include cases where a SLIV is utilized but may not exceed one slot in length while there are often multiple control channel symbols in a given slot, and thus, the number of REs in prior solutions has a relatively low maximum number and limits the TBS, and further complexities associated with CB segmentation and rate matching lead to additional inefficiencies. Further, solutions that utilize a jumbo TB of a PxSCH with a long-SLIV to cross slot boundaries have limitations related to TBS and Rx support leading to additional segmentation. Such additional segmentation, however, does not include solutions to account for a TB that spans multiple slots and gap boundaries (e.g., a slot gap, an uplink gap, etc.) where the interference may become more uncorrelated and the CB BLER may change. Nor do current solutions provide configurations for scenarios in which a base station/gNB may assume or determine that such interference may be correlated to advantageously skip gaps.

Aspects herein for PxSCH TBS and CBs for long-SLIV with gaps improve upon the issues noted above. An Rx/Tx device may account for gap boundaries and enable TBs to span multiple slots and prevent issues with associated CBs by utilizing a PxSCH with a long-SLIV. An Rx/Tx device may partition time resources of a PxSCH into time segments based on gaps and a long-SLIV for a TB(s), in which sub-TBs may be generated from the TB(s) and across/within the time segments, for transmission to another Rx/Tx device, and individual segments may be configured for RVs based on a respective sub-TBS. Aspect extend PxSCH coverage with minimal complexity and reduced DMRS overhead by utilizing time resource partitioning and TB segmentation for a PxSCH with a long-SLIV, as well as a more uniform time domain DMRS pattern (e.g., given Doppler). Aspects enable the spanning of PxSCH TBs over multiple slots and account for uncorrelated interference and slot boundaries/gaps by utilizing time resource partitioning and TB segmentation for a PxSCH with a long-SLIV. Aspects enable the spanning of PxSCH TBs over multiple slots while maintaining CBs within slots/time segments by calculating/determining the TBS, as well as CB segmentation, rate matching, and concatenation with reference to slot boundaries. Aspects enable the application of an associated a CRC and ACK/NACK per CBG by configuring CBGs within slots/time segments to have the same/similar interference. Aspects also provide for allocation PxSCH TBs and advantageously account for correlated interference across the long-SLIV time span by utilizing DCI for dynamic gap skipping.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first receiver (Rx)/transmitter (Tx) (Rx/Tx) device, comprising: partitioning time resources associated with a physical uplink/downlink shared channel (PxSCH) into a set of time segments based on physical gaps or logical gaps and based on a long start and length indicator value (long-SLIV) associated with a PxSCH transport block (TB) for the PxSCH, wherein the set of time segments includes two or more time segments and at least two time segments in the set of time segments are separated by a physical gap or a logical gap; generating a set of sub-TBs, comprising the PxSCH TB, across the set of time segments, wherein each sub-TB of the set of sub-TBs is within a time segment of the set of time segments; and transmitting, to a second Rx/Tx device, the PxSCH TB.

Aspect 2 is the method of aspect 1, wherein the PxSCH TB includes a set of code blocks (CBs), wherein each CB of the set of CBs is within one of the set of time segments.

Aspect 3 is the method of aspect 2, wherein time resource characteristics of the time resources have a per-segment association for the set of time segments, wherein the time resource characteristics include at least one of a sub-TB size (sub-TBS) of each sub-TB of the set of sub-TBs, each CB of the set of CBs, a CB segmentation, a cyclic redundancy check (CRC), a rate matching, or a CB concatenation.

Aspect 4 is the method of aspect 3, wherein the time resource characteristics, for each time segment of the set of time segments, are based on at least one of a number of available resource elements (REs) or a number of unquantized information bits in each time segment of the set of time segments, wherein each time segment of the set of time segments has a same modulation order and a same number of layers.

Aspect 5 is the method of aspect 3, wherein each time segment of the set of time segments is associated with a respective low density parity check (LDPC) base graph based on the sub-TBS of each time segment; or wherein each time segment of the set of time segments is associated with a same LDPC base graph based on at least one of a minimum sub-TBS, a maximum sub-TBS, or an average sub-TBS over the set of time segments.

Aspect 6 is the method of aspect 5, wherein each time segment includes at least one CB; and wherein a number of CBs in the set of CBs and a number of sub-TBs in the set of sub-TBs are based on a number of unquantized information bits in each time segment of the set of time segments for each time segment individually or for the set of time segments jointly.

Aspect 7 is the method of aspect 3, wherein the CRC includes a single CRC associated with the PxSCH TB; or wherein the CRC includes a set of sub-CRCs associated with each sub-TB or associated with each time segment in the set of time segments.

Aspect 8 is the method of aspect 7, wherein each sub-CRC in the set of sub-CRCs is associated with at least one of an acknowledgement (ACK)/negative ACK (ACK/NACK) or a retransmission having a per-sub-TB granularity.

Aspect 9 is the method of aspect 3, wherein the CB segmentation is associated with each sub-TB of the set of sub-TBs, subsequent to an application of the CRC and a respective low density parity check (LDPC) base graph selection, in accordance with a CB number for each CB in the set of CBs and a number of bits for each CB number.

Aspect 10 is the method of aspect 3, wherein the rate matching and the CB concatenation are associated with each time segment of the set of time segments and are based on a ratio of a number of coded bits for a channel coding to a number of CBs in a respective time segment of the set of time segments.

Aspect 11 is the method of aspect 2, wherein at least one time segment of the set of time segments includes a respective set of CB groups (CBGs), wherein each respective set of CBGs includes a number of CBs of the set of CBs and is within a respective time segment of the set of time segments.

Aspect 12 is the method of aspect 11, wherein the number of CBs in each CBG of each respective set of CBGs is based on a per-time segment configuration for the at least one time segment of the set of time segments.

Aspect 13 is the method of any of aspects 1 to 12, further comprising: receiving downlink control information (DCI) indicative of a skip for at least one physical gap or at least one logical gap, wherein the skip is (i) associated with a TB segmentation or a CB segmentation and (ii) in accordance with an interference correlation for sub-TBs separated by the at least one physical gap or the at least one logical gap.

Aspect 14 is the method of aspect 13, wherein the DCI indicates the at least one logical gap as an uplink gap or a transmission time interval (TTI) to TTI gap associated with a time division duplex (TDD) frame structure in at least one of radio resource control (RRC) signaling or a slot format indication (SFI); or wherein the DCI identifies the at least one physical gap for the skip.

Aspect 15 is the method of aspect 13, wherein the DCI indicates the at least one physical gap or the at least one logical gap (i) by a reference to a data structure associated with enumerated gap patterns or (ii) by an association with a time division duplex (TDD) frame structure.

Aspect 16 is the method of any of aspects 1 to 15, wherein the first Rx/Tx device is a user equipment (UE) and the second Rx/Tx device is a network node, wherein the PxSCH is a physical uplink downlink shared channel (PUSCH); or wherein the first Rx/Tx device is the network node and the second Rx/Tx device is the UE, wherein the PxSCH is a physical downlink shared channel (PDSCH).

Aspect 17 is an apparatus for wireless communication at a first receiver (Rx)/transmitter (Tx) (Rx/Tx) device, comprising: at least one memory; and at least one processor coupled to the at least one memory, the at least one processor, individually or in any combination, is configured to perform the method of any of aspects 1 to 16.

Aspect 18 is an apparatus for wireless communication at a first receiver (Rx)/transmitter (Tx) (Rx/Tx) device, comprising means for performing each step in the method of any of aspects 1 to 16.

Aspect 19 is the apparatus of any of aspects 17 and 18, further comprising a transceiver configured to receive or to transmit in association with the method of any of aspects 1 to 16.

Aspect 20 is a computer-readable medium (e.g., a non-transitory computer-readable medium) storing computer executable code at a first receiver (Rx)/transmitter (Tx) (Rx/Tx) device, the code when executed by at least one processor causes the at least one processor to perform the method of any of aspects 1 to 16.

What is claimed is:

1. An apparatus for wireless communication at a first receiver (Rx)/transmitter (Tx) (Rx/Tx) device, comprising:
at least one memory; and
at least one processor coupled to the at least one memory and, based at least in part on information stored in the at least one memory, the at least one processor, individually or in any combination, is configured to:
partition time resources associated with a physical uplink/downlink shared channel (PxSCH) into a set of time segments based on physical gaps or logical gaps and based on a long start and length indicator value (long-SLIV) associated with a PxSCH transport block (TB) for the PxSCH, wherein the set of time segments includes two or more time segments and at least two time segments in the set of time segments are separated by a physical gap or a logical gap;
generate a set of sub-TBs, comprising the PxSCH TB, across the set of time segments, wherein each sub-TB of the set of sub-TBs is within a time segment of the set of time segments; and
transmit, to a second Rx/Tx device, the PxSCH TB.

2. The apparatus of claim 1, wherein the PxSCH TB includes a set of code blocks (CBs), wherein each CB of the set of CBs is within one of the set of time segments.

3. The apparatus of claim 2, wherein time resource characteristics of the time resources have a per-segment association for the set of time segments, wherein the time resource characteristics include at least one of a sub-TB size (sub-TBS) of each sub-TB of the set of sub-TBs, each CB of the set of CBs, a CB segmentation, a cyclic redundancy check (CRC), a rate matching, or a CB concatenation.

4. The apparatus of claim 3, wherein the time resource characteristics, for each time segment of the set of time segments, are based on at least one of a number of available resource elements (REs) or a number of unquantized information bits in each time segment of the set of time segments, wherein each time segment of the set of time segments has a same modulation order and a same number of layers.

5. The apparatus of claim 3, wherein each time segment of the set of time segments is associated with a respective low density parity check (LDPC) base graph based on the sub-TBS of each time segment; or
wherein each time segment of the set of time segments is associated with a same LDPC base graph based on at least one of a minimum sub-TBS, a maximum sub-TBS, or an average sub-TBS over the set of time segments.

6. The apparatus of claim 5, wherein each time segment includes at least one CB; and
wherein a number of CBs in the set of CBs and a number of sub-TBs in the set of sub-TBs are based on a number of unquantized information bits in each time segment of the set of time segments for each time segment individually or for the set of time segments jointly.

7. The apparatus of claim 3, wherein the CRC includes a single CRC associated with the PxSCH TB; or
wherein the CRC includes a set of sub-CRCs associated with each sub-TB or associated with each time segment in the set of time segments.

8. The apparatus of claim 7, wherein each sub-CRC in the set of sub-CRCs is associated with at least one of an acknowledgement (ACK)/negative ACK (ACK/NACK) or a retransmission having a per-sub-TB granularity.

9. The apparatus of claim 3, wherein the CB segmentation is associated with each sub-TB of the set of sub-TBs, subsequent to an application of the CRC and a respective low density parity check (LDPC) base graph selection, in accordance with a CB number for each CB in the set of CBs and a number of bits for each CB number.

10. The apparatus of claim 3, wherein the rate matching and the CB concatenation are associated with each time segment of the set of time segments and are based on a ratio of a number of coded bits for a channel coding to a number of CBs in a respective time segment of the set of time segments.

11. The apparatus of claim 2, wherein at least one time segment of the set of time segments includes a respective set of CB groups (CBGs), wherein each respective set of CBGs includes a number of CBs of the set of CBs and is within a respective time segment of the set of time segments.

12. The apparatus of claim 11, wherein the number of CBs in each CBG of each respective set of CBGs is based on a per-time segment configuration for the at least one time segment of the set of time segments.

13. The apparatus of claim 1, further comprising at least one transceiver coupled to the at least one processor, wherein the at least one processor, individually or in any combination, is further configured to:
receive, via the at least one transceiver, downlink control information (DCI) indicative of a skip for at least one physical gap or at least one logical gap, wherein the skip is (i) associated with a TB segmentation or a CB segmentation and (ii) in accordance with an interference correlation for sub-TBs separated by the at least one physical gap or the at least one logical gap.

14. The apparatus of claim 13, wherein the DCI indicates the at least one logical gap as an uplink gap or a transmission time interval (TTI) to TTI gap associated with a time division duplex (TDD) frame structure in at least one of radio resource control (RRC) signaling or a slot format indication (SFI); or
wherein the DCI identifies the at least one physical gap for the skip.

15. The apparatus of claim 13, wherein the DCI indicates the at least one physical gap or the at least one logical gap (i) by a reference to a data structure associated with enumerated gap patterns or (ii) by an association with a time division duplex (TDD) frame structure.

16. The apparatus of claim 1, wherein the first Rx/Tx device is a user equipment (UE) and the second Rx/Tx device is a network node, wherein the PxSCH is a physical uplink downlink shared channel (PUSCH); or
wherein the first Rx/Tx device is the network node and the second Rx/Tx device is the UE, wherein the PxSCH is a physical downlink shared channel (PDSCH).

17. A method of wireless communication at a first receiver (Rx)/transmitter (Tx) (Rx/Tx) device, comprising:
partitioning time resources associated with a physical uplink/downlink shared channel (PxSCH) into a set of time segments based on physical gaps or logical gaps and based on a long start and length indicator value (long-SLIV) associated with a PxSCH transport block (TB) for the PxSCH, wherein the set of time segments includes two or more time segments and at least two time segments in the set of time segments are separated by a physical gap or a logical gap;
generating a set of sub-TBs, comprising the PxSCH TB, across the set of time segments, wherein each sub-TB of the set of sub-TBs is within a time segment of the set of time segments; and
transmitting, to a second Rx/Tx device, the PxSCH TB.

18. The method of claim 17, wherein the PxSCH TB includes a set of code blocks (CBs), wherein each CB of the set of CBs is within one of the set of time segments, wherein time resource characteristics of the time resources have a per-segment association for the set of time segments, wherein the time resource characteristics include at least one of a sub-TB size (sub-TBS) of each sub-TB of the set of sub-TBs, each CB of the set of CBs, a CB segmentation, a cyclic redundancy check (CRC), a rate matching, or a CB concatenation.

19. A computer-readable medium storing computer executable code at a first receiver (Rx)/transmitter (Tx) (Rx/Tx) device, the code when executed by at least one processor causes the at least one processor to:
partition time resources associated with a physical uplink/downlink shared channel (PxSCH) into a set of time segments based on physical gaps or logical gaps and based on a long start and length indicator value (long-SLIV) associated with a PxSCH transport block (TB) for the PxSCH, wherein the set of time segments includes two or more time segments and at least two time segments in the set of time segments are separated by a physical gap or a logical gap;
generate a set of sub-TBs, comprising the PxSCH TB, across the set of time segments, wherein each sub-TB of the set of sub-TBs is within a time segment of the set of time segments; and
transmit, to a second Rx/Tx device, the PxSCH TB.

20. The computer-readable medium of claim 19, wherein the PxSCH TB includes a set of code blocks (CBs), wherein each CB of the set of CBs is within one of the set of time segments, wherein time resource characteristics of the time resources have a per-segment association for the set of time segments, wherein the time resource characteristics include at least one of a sub-TB size (sub-TBS) of each sub-TB of the set of sub-TBs, each CB of the set of CBs, a CB segmentation, a cyclic redundancy check (CRC), a rate matching, or a CB concatenation.
